(19) United States
(12) Patent Application Publication
(10) Pub. No.: US 2012/0010767 A1
(43) Pub. Date: Jan. 12, 2012

(54) HYBRID ELECTRIC VEHICLE AND METHOD OF CONTROL USING PATH FORECASTING

(75) Inventors: Anthony Mark Phillips, Northville, MI (US); Georgia-Evangelia Katsargyri, Cambridge, MA (US); Ming Lang Kuang, Canton, MI (US); Ilya Vladimir Kolmanovsky, Novi, MI (US); John Ottavio Michelini, Sterling Heights, MI (US); Munther Abdullah Dahleh, Cambridge, MA (US); Michael David Rinehart, Quincy, MA (US)

(73) Assignees: MASSACHUSETTS INSTITUTE OF TECHNOLOGY, Cambridge, MA (US); FORD GLOBAL TECHNOLOGIES, LLC, Dearborn, MI (US)

(21) Appl. No.: 13/157,533

(22) Filed: Jun. 10, 2011

Related U.S. Application Data
(60) Provisional application No. 61/353,401, filed on Jun. 10, 2010.

(51) Int. Cl. G01C 21/00

(52) U.S. Cl. 701/22; 180/65.21; 903/903

(57) ABSTRACT

A path-dependent control of a hybrid electric vehicle (HEV) includes segmenting a route into segments, generating a sequence of battery state-of-charge (SoC) set-points for the segments, and controlling the vehicle in accordance with the battery SoC set-points as the vehicle travels along the route.

### CROSS-REFERENCE TO RELATED APPLICATIONS

This application claims the benefit of U.S. Provisional Application No. 61/353,401, filed Jun. 10, 2010; the disclosure of which is hereby incorporated by reference in its entirety.

### TECHNICAL FIELD

The present invention relates to path-dependent control of hybrid electric vehicles.

### BACKGROUND

A hybrid electric vehicle (HEV) includes two power sources for delivering power to propel the vehicle. Typically, the first power source is an internal combustion engine which consumes fuel and the second power source is a battery which stores and uses electricity. The fuel economy of a HEV for a given route can be improved if the battery usage is adapted for the route.

### SUMMARY

As indicated above, the fuel economy of a hybrid electric vehicle (HEV) can be improved for a given traveling route or path if the battery usage is adapted for the route or path. As such, in accordance with embodiments of the present invention, the control of a HEV (including non-plug-in and plug-in HEVs) is tied to an expected or specified route in order to reduce fuel consumption and thereby improve fuel economy. Utilizing available route information including road characteristics, vehicle conditions, and traffic conditions, the battery charging and discharging is optimized for the route. The proliferation of navigation systems and digital maps in modern vehicles can facilitate the application of such path-dependent control methods for HEVs.

Embodiments of the present invention seek to improve the fuel economy of a HEV for a route by optimizing the charging and discharging of the battery depending on the route. In accordance with embodiments of the present invention, a route to be traveled by the vehicle is known in advance by being predicted, expected, forecasted, driver-specified, etc. The route is decomposed into a series of route segments. Properties of each route segment such as length, grade, and vehicle speed trajectories or patterns are known or expected. To this end, the route is decomposed into the series of route segments such that the nodes where one route segment ends and where another route segment begins correspond to the initiation of a significant change in characteristics of the route such as vehicle speed, road grade, the presence of stop signs or traffic lights, traffic congestion, and the like. An optimized sequence of battery state-of-charge (SoC) set-points for the route segments is generated. The battery SoC set-points are optimized in the sense that the fuel consumption of the vehicle in traveling the route will be minimized in response to the battery being controlled in accordance with the battery SoC set-points. The battery SoC set-points may be generated based on one or more of the properties of the route segments. The battery is controlled at each route segment in accordance with the battery SoC set-point for that segment as the vehicle travels along the route.

A general approach of embodiments of the present invention is based on considering the expected fuel consumption over the route as a function of the battery SoC set-points in each route segment, the known properties of each route segment, and the expected characteristics of vehicle speed trajectories in each route segment. An optimization algorithm can then be applied to generate the sequence of battery SoC set-points for the route segments.

That is, the general approach to HEV path-dependent control in accordance with embodiments of the present invention is based on a special route segmentation policy and a battery SoC optimization algorithm. To this end, an expected route between an origin and a destination is decomposed into a series of route segments connected to each other and linking the origin to the destination. For each route segment, the road grade, the segment length, and the expected vehicle speed along the route segment are available. The route segmentation is not based on route segments of equal length or equal travel duration, but rather on the available information of the route segments. In particular, the route segments correspond to significant changes in characteristics of the route such as vehicle speed, road grade, the presence of stop signs and traffic lights, traffic congestion, and the like. A controller, based on the optimization algorithm, prescribes an energy management policy for the most fuel efficient travel between the origin and the destination based on the available information of the route segments.

In an embodiment, a method is provided. The method includes segmenting a route into segments, generating a sequence of battery SoC set-points for the segments, and controlling a HEV in accordance with the battery SoC set-points as the vehicle travels along the route.

In an embodiment, a system is provided. The system includes a controller configured to segment a route into segments, generate a sequence of battery SoC set-points for the segments, and control a HEV in accordance with the battery SoC set-points as the vehicle travels along the route.

### BRIEF DESCRIPTION OF THE DRAWINGS

FIG. 1 illustrates a schematic representation of a hybrid electric vehicle (HEV) capable of embodying the present invention;

FIG. 2 illustrates a block diagram indicative of the input and output configuration of the vehicle system controller of the HEV;

FIG. 3 illustrates a route to be traveled segmented into route segments in accordance with embodiments of the present invention;

FIG. 4 illustrates state-of-charge (SoC) quantization for the nodes of the segmented route in accordance with embodiments of the present invention; and

FIG. 5 illustrates a graph of the vehicle speed trajectories for the route segments of a sample route used to quantify potential benefits of path-dependent control in accordance with embodiments of the present invention.

### DETAILED DESCRIPTION

Detailed embodiments of the present invention are disclosed herein; however, it is to be understood that the disclosed embodiments are merely exemplary of the present invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

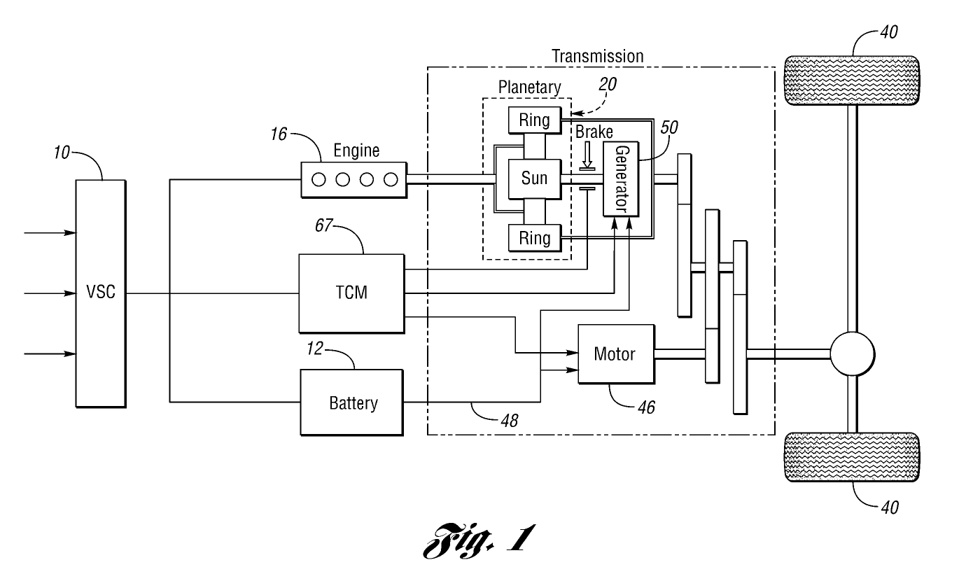

Referring now to FIG. 1, a schematic representation of a hybrid electric vehicle (HEV) capable of embodying the present invention is shown. The basic components of the HEV powertrain include an internal combustion engine 16, an electric battery 12, a power split device referred to as a planetary gear set 20, an electric motor 46, and an electric generator 50. The HEV powertrain has a power-split configuration. This configuration allows engine 16 to directly drive wheels 40 and at the same time charge battery 12 through generator 50. Furthermore, both battery 12 and engine 16 can drive wheels 40 independently.

Engine 16 is connected to generator 50 through planetary gear set 20. Battery 12 is connected to motor 46 and generator 50. Battery 12 can be recharged or discharged by motor 46 or generator 50 or both. Planetary gear set 20 splits the power produced by engine 16 and transfers one part of the power to drive wheels 40. Planetary gear set 20 transfers the remaining part of the power to generator 50 in order to either provide electrical power to motor 46 or to recharge battery 12.

Engine 16 can provide mechanical power to wheels 40 and at the same time charge battery 12 through generator 50. Depending on the operating conditions, engine 16, motor 46 (which consumes electric energy stored in battery 12), or both can provide power to wheels 40 to propel the vehicle. The vehicle also incorporates a regenerative braking capability to charge battery 12 during vehicle deceleration events. As described, there are several degrees of freedom in this powertrain configuration to satisfy driver requests. This flexibility can be exploited to optimize fuel consumption.

A hierarchical vehicle system controller 10 coordinates subsystems in the HEV. Controller 10 is used to capture all possible operating modes and integrate the two power sources, engine 16 and battery 12, to work together seamlessly and optimally as well as to meet the driver's demand. Controller 10 is configured to send control signals to and receive sensory feedback information from one or more of battery 12, engine 16, motor 46, and generator 50 in order for power to be provided to wheels 40 for propelling the vehicle. Controller 10 controls the power source proportioning between battery 12 and engine 16 to provide power to propel the vehicle. As such, controller 10 controls the charging and discharging of battery 12 and thereby controls the state of charge (SoC) of battery 12. Inherent to controller 10 is a logical structure to handle various operating modes and a dynamic control strategy associated with each operating mode to specify the vehicle requests to each subsystem. A transmission control module (TCM) 67 transmits the commands of controller 10 to motor 46 and generator 50.

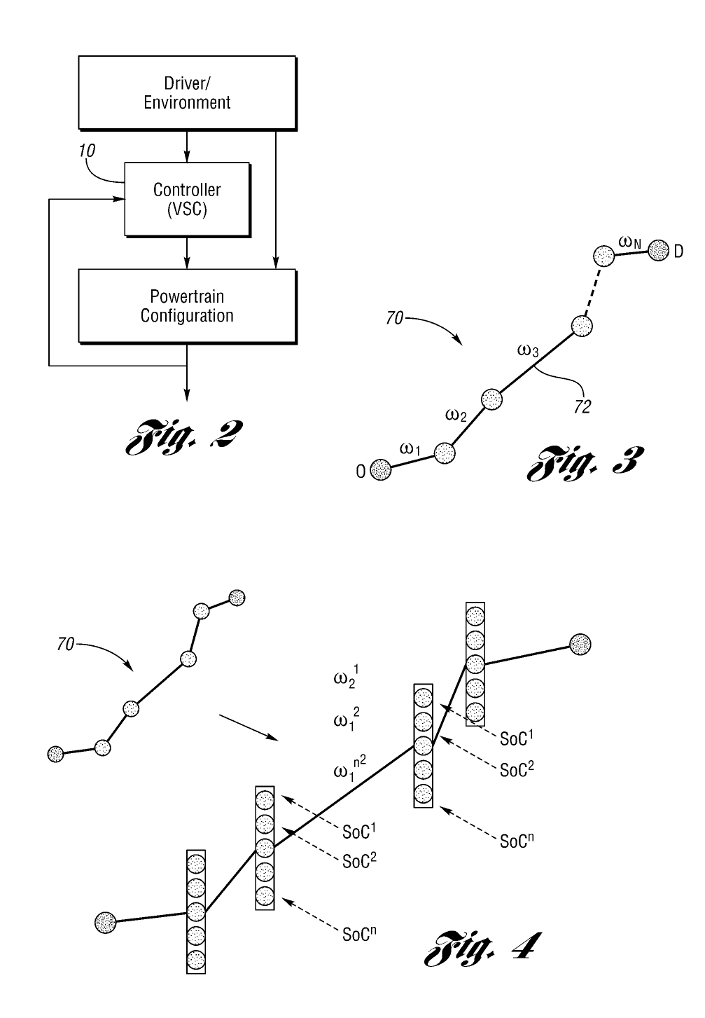

As shown in FIG. 2, controller 10 takes as inputs environmental conditions, the driver's requests, and the current state of the vehicle and provides as outputs commands such as torque and speed commands for the powertrain components of the vehicle. The powertrain then follows the commands of controller 10.

In order to handle path-dependent control in accordance with embodiments of the present invention, controller 10 is extended with additional functionality to optimize fuel consumption. In particular, the environmental condition inputs for controller 10 include road length, road grade, and vehicle speed of a route to be traveled by the vehicle. The current state of the vehicle as represented by the state-of-charge (SoC) of battery 12 is also an input to controller 10. In order to improve fuel economy, controller 10 controls the transitions from charging to discharging mode and the durations of charging and discharging periods. Towards this goal, controller 10 determines the battery SoC set-points for the route and tracks the battery SoC in order to realize these charging and discharging transitions that result in the most fuel efficient travel. Ideally, battery SoC set-points would be prescribed for every moment of travel along the route. However, to simplify the computations, the route is decomposed into route segments and battery SoC set-points are respectively prescribed for the route segments. The segmentation enables controller 10 to accurately track the corresponding battery SoC before the end of each route segment. The additional functionality of controller 10 to optimize fuel consumption will now be described in greater detail below.

Referring now to FIG. 3, an approach to modeling fuel consumption of travel over a route in accordance with embodiments of the present invention will now be described. FIG. 3 illustrates a route 70 to be traveled segmented into route segments 72 in accordance with embodiments of the present invention. Route 70 links an origin O to a destination D. Route 70 is decomposed into a series of i=1, . . . , N route segments 72 connected to one another. In FIG. 3, the ωᵢ designates the fuel consumed over the ith segment.

Each route segment i has a length lᵢ, a road grade gᵢ, and a vehicle speed vᵢ. This information for each route segment is available (e.g., known or predicted) in advance of the vehicle traveling along the route segment. The road grade and the vehicle speed for each route segment are generally functions of distance and time. The road grade is a deterministic quantity which can be known in advance as a function of distance. With respect to modeling the vehicle speed, it is assumed that a nominal vehicle speed trajectory can be predicted for each route segment, possibly dependent on the characteristics of the route segment and traffic in the route segment.

In accordance with embodiments of the present invention, the route segmentation criteria generally relate to substantial changes in characteristics of the route such as the average road grade or average vehicle speed. Such substantial changes in the road grade may correspond to the beginning or end of a hill. Such substantial changes for the vehicle speed may coincide with the changes in the road class, deceleration to or acceleration from stop signs or traffic lights, or to traffic conditions.

Consequently, a constant average road grade gᵢ can be assumed in each route segment. At the same time, a varying nominal vehicle speed trajectory vᵢ is considered in each route segment. Such a representative vehicle speed trajectory (a scenario) may be chosen consistently with a finite set of statistical features (mean, variance, etc.) which are considered to be properties of traffic on a particular route segment or type of driver.

The state-of-charge (SoC) of battery 12 is a key dynamic state in the system. The value of the battery SoC at the beginning of the ith route segment is denoted as SoCᵢ and the value of the battery SoC at the end of the ith route segment is denoted as SoCᵢ₊₁. The value of the battery SoC set-point in the ith route segment is denoted as SoC_{d}(i). Controller 10 controls the battery SoC in the ith route segment in response to the battery SoC set-point SoC_{d} for the ith route segment.

The expected fuel consumption w, in the ith route segment is thus a function of gᵢ, vᵢ, lᵢ, SoCᵢ, and SoC_{d}(i), i.e.,

ωᵢ(gᵢ,vᵢ,lᵢ,SoCᵢ,SoC_{d}(i))=E{f(gᵢ,vᵢ,lᵢ,SoCᵢ,SoC_{d}(i))} (equation 1)

E denotes the expected value. The expectation is used in equation 1 because the actual vehicle speed trajectory is generally not deterministic and can deviate from the nominal trajectory (e.g., due to different driver and traffic situations) and hence the fuel consumption is a random variable. In particular, although the grade, the nominal vehicle speed, and the length of a route segment are deterministic quantities, the vehicle speed trajectory over the route segment is not. Different drivers may produce different vehicle speed profiles while maintaining the same average speed. Even the same driver will never be able to regenerate completely accurately a previously realized vehicle trajectory. Environmental conditions including severe weather and traffic situations and even the personality and mood of the driver may affect the vehicle speed trajectory on every trip. Therefore, vehicle speed trajectory is a probabilistic quantity. Consequently, even though a nominal speed on a route segment or a more realistic speed model is given, this information is not sufficient to compute a reliable value for the fuel consumption along a route segment. Thus, a value representative enough for every type of driver and every environmental situation has to be considered for the fuel consumption of a route segment. An appropriate way to satisfy this goal is to consider the expected value of the fuel consumption over multiple probabilistic realizations of vehicle speed. Accordingly, a large number of speed trajectories around an originally given speed model is generated probabilistically for each route segment. For all of those speed trajectories, the corresponding fuel consumption (i.e., {f(gᵢ, vᵢ, lᵢ, SoCᵢ, SoC_{d}(i))}) is computed. The expected value (i.e., E{f(gᵢ, vᵢ, lᵢ, SoCᵢ, SoC_{d}(i))}) of those fuel consumptions is the representative fuel consumption of the route segment that will be provided as input to the optimization algorithm as described herein.

As indicated above, controller 10 includes a high-level portion which prescribes the battery SoC set-points for the route and a low-level portion which tracks the battery SoC in order to minimize the total expected fuel consumption along the route. The high-level controller portion is a “planner” in that it plans the route by prescribing the battery SoC for each route segment. The low-level controller portion controls the battery SoC to its prescribed battery SoC set-point within each route segment. The low-level controller portion takes as inputs the battery SoC at the beginning of each route segment, the grade of the route segment, the vehicle speed of the route segment, the length of the route segment, and the target battery SoC at the end of the route segment (i.e., the battery SoC set-point at the beginning of the next route segment). Of course, the low-level controller also receives as inputs typical vehicle information such as driver power request, auxiliary power loads, motor speed, engine speed, etc. Based on the inputs, the low-level controller portion generates torque and speed commands for the HEV components to ensure tracking of the battery SoC set-point for the route segment. As described herein, the route segments segmented in accordance with embodiments of the present invention will likely have different lengths in order to provide more efficient aggregation of the relevant route conditions.

An approach where Monte Carlo simulations are employed to average the fuel consumption over several vehicle speed trajectory scenarios may be implemented. In sum, there are developments related to fuel consumption modeling from simulated or experimental vehicle data. Embodiments of the present invention rely on the assumption that a representative fuel consumption model (e.g., equation 1) has been developed.

In accordance with embodiments of the present invention, as indicated above, controller 10 has route planner functionality to implement path-dependent control. The route planner functionality provides an optimization approach to generate battery SoC set-points for the individual route segments of a route. After a route has been segmented into route segments with certain properties of each route segment being known, controller 10 prescribes a sequence of battery SoC set-points {SoC_{d}(i), i=1, . . . , N} for the route to minimize the total fuel consumption. The sequence of battery SoC set-points is generated based on the known properties of the route segments. Controller 10 controls the battery SoC in the ith route segment in response to the battery SoC set-point SoC_{d}(i) for the ith route segment.

As indicated above, a given route is decomposed into a series of route segments connected to each other with nodes linking the origin to the destination. Pursuant to the prescribed sequence of battery SoC set-points, the battery SoC set-point is updated at every node (i.e., at the beginning of each route segment) and the battery SoC set-point remains the same as the vehicle travels along the route segment.

Let i be the current node and the beginning of the ith route segment, i=1, 2, . . . , N+1, where i=1 and i=N+1 represent, respectively, the origin and destination nodes of the route. The route planner functionality incorporates a control law which is a function of the state vector x(i) with two components: the segment/node i and the state of charge SoCᵢ at that node. The state dynamics are:

$$x ( i + 1 ) = F ( x ( i ) , {SoC}_{d} ( i ) ) , and \\ x ( i ) = ( \begin{matrix}i \\ SoCi\end{matrix} ) . \qquad ( equation 2 )$$

The state at the current node is x(i). F is a nonlinear function which generates a successor state from the precedent state.

The objective of minimizing the total fuel consumption along the route can be formulated as follows:

minJ[SoC_{d}(i)]=Σᵢ₌₁^{N}ωᵢ (equation 3)

subject to SoCₘᵢₙ≦SoCᵢ₊₁≦SoCₘₐₓ and subject to SoC_{N+1}=SoC_{D}.

J is the objective function of the optimization problem. SoC_{d}(i) (i [symbol] {1, 2, 3, . . . N}) are the manipulated variables. SoCₘᵢₙ and SoCₘₐₓ, are respectively the minimum and maximum SoC limits. J is a stage-additive cost function and the stage cost reflects the expected fuel consumption in each route segment i. The constraint SoC_{N+1}=SoC_{D} is an optional constraint to match the battery SoC to the desired battery SoC value at the end of the route. The choice SoC_{D}=SoC_{O} ensures that the battery charge is sustained over the route.

In accordance with embodiments of the present invention, the route is segmented into route segments sufficiently long such that feasible battery SoC set-points can be tracked within the route segments. That is, the battery SoC at the beginning of the next route segment is equal to the battery SoC set-point during the preceding route segment (i.e., SoCᵢ₊₁=SoC_{d}(i)).

In such a case, the dynamics of equation 4 (set forth below) are simple and the problem complexity is relegated to the fuel consumption model pursuant to equation 1. Further, if the fuel consumption can be approximated by a quadratic function of SoCᵢ and SoC_{d}(i), the optimization problem (equation 3) reduces to a quadratic programming problem which can be solved using standard quadratic programming solvers. More general situations can be handled with the optimization algorithm as discussed below.

The optimization algorithm employed by controller 10 translates the property of any final part of an optimal trajectory to be optimal with respect to its initial state into a computational procedure in which the cost-to-go function J*(x) can be recursively computed and satisfies the following relationships:

J*(x)=min[SoC_{d}]{J*(F(x,SoC_{d}))+ω(x,SoC_{d})}, (equation 4)

and

J*(x_{f})=0. (equation 5)

SoC_{d}=SoC_{d}(x) is the decision variable. The variable ω(x, SoC_{d}) denotes the expected fuel consumption for the state x and the battery SoC set-point SoC_{d}. At every route segment i, the optimal cost J*(x) is computed by minimizing over all the sums of the optimal cost-to-go function J*(F(x, SoC_{d})) at segment i+1 plus the cost to move from segment i to segment i+1, for all the possible decisions SoC_{d} that can be taken at segment i. The final state in equation 5 is denoted by x_{f}=x(N+1).

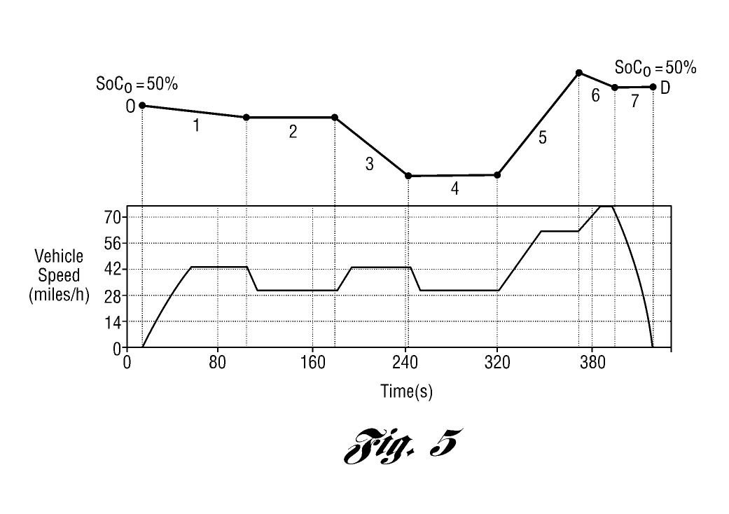

As the model pursuant to equation 4 is low dimensional, the effort to numerically compute the DP solution is containable. In the implementation of these computations, the values of SoC and SoC_{d} are quantized so that SoCᵢ, SoC_{d}(i) [symbol] {SoC¹, SoC², . . . SoCⁿ} with SoC¹≦Soc²≦ . . . ≦SoCⁿ. Then every node i of the route may be associated with all possible quantization values as shown in FIG. 4. As a consequence, the number of all possible values that the expected fuel consumption ω for each route segment may assume is equal to the amount of all possible combinations of (SoCᵢ, SoC_{d}(i)) with SoCᵢ and SoC_{d}(i) quantized. The number of all these possible combinations is n² and thus the expected fuel consumption ω can take n² different values for a given route segment.

To quantify the potential benefits of path-dependent control in accordance with embodiments of the present invention, several case studies were considered. In these case studies, the road grade and the vehicle speed trajectory in each route segment were assumed to be known. The expected fuel consumption was therefore a deterministic quantity and no averaging with respect to random realizations of the vehicle speed trajectory was employed.

Case studies based on a sample route with zero road grade and with non-zero road grade will now be described. The sample route was decomposed into seven route segments (i.e., N=7). Length and grade information for each route segment and the vehicle speed trajectory in each route segment were assumed to be available and known in advance. Table I below indicates the length and road grade of each route segment of the sample route. FIG. 5 illustrates a graph of the vehicle speed trajectory in each route segment of the sample route.

TABLE I

| | Segment | | | | | | |
|---|---|---|---|---|---|---|---|
| | 1 | 2 | 3 | 4 | 5 | 6 | 7 |
| Length | 0.87 | 0.68 | 0.74 | 0.98 | 1.02 | 0.59 | 0.42 |
| (miles) | | | | | | | |
| Grade (%) | 0 | 0 | 0 | 0 | 0 | 0 | 0 |

As indicated in Table I, the road grade was assumed to be zero along the entire route. The battery SoC at the route origin (i.e., at the beginning of route segment 1) is SoC_{O}=50%. To sustain the charge in battery 12, the desired battery SoC at the route destination (i.e., at the end of route segment 7) is SoC_{D}=50%. The values of SoCₘᵢₙ and SoCₘₐₓ were set to 40% and 60%, respectively.

Table II below compares the fuel consumption with the battery SoC set-point sequence prescribed by the optimization policy (referred to as “DP SoC Control” case) and the fuel consumption when SoC_{d}(i)=50% in each route segment (referred to as “No SoC Control” case). The fuel consumption (0.32 kg) when the battery is controlled in accordance with the prescribed battery SoC set-point sequence is about 13.5% lower than the fuel consumption (0.37 kg) when the battery SoC is maintained constant over the entire route. As further indicated in table II, the prescribed battery SoC set-point sequence is “50-52-50-48-46-46-44-50”. As such, the battery SoC set-points for the 1^{st} and 8^{th} nodes (i.e., the origin and destination) are 50%. The battery SoC set-points for the 2^{nd} through 7^{th} nodes are 52%, 50%, 48%, 46%, 46%, and 44%, respectively.

TABLE II

| | Total Fuel | |
|---|---|---|
| FUEL SAVINGS 13.5% | Consumption (kg) | SoC_{d} sequence (%) |
| No SoC control | 0.37 | 50-50-50-50-50-50-50-50 |
| DP SoC control | 0.32 | 50-52-50-48-46-46-44-50 |

As described above, and as can be seen in Table I, the route segmentation in accordance with embodiments of the present invention is not based on route segments of equal length or equal travel duration, but rather on available vehicle speed information. In particular, the nodes where one route segment ends and another begins (and where battery SoC control points are located) correspond to the initiation of a significant change in average vehicle speed. As indicated in FIG. 5, the nominal vehicle speed trajectory is constructed so that in each route segment a constant rate of acceleration or deceleration to the new vehicle speed value is assumed followed by steady cruise at that speed.

This route segmentation in accordance with embodiments of the present invention is effective in the sense that it takes advantage of the vehicle speed information availability while other ways of decomposing the route would result in route segments of varying vehicle speeds within them. In contrast, using a segmentation method that unifies route segments of different characteristics into one results will likely result in greater fuel consumption. For example, if route segments 4 and 5 of the sample route were considered as one route segment, ignoring the significant difference between their average vehicle speeds (see FIG. 5), the total fuel consumption would increase.

In another case study involving the sample route, a non-zero grade was inserted at route segment 2 while the rest of the characteristics of the sample route remain unchanged. Table III below compares the fuel consumption in “No SoC control” case with fuel consumption in “DP SoC control with grade ignored” case and “DP SoC control with grade included” case. The second case employs the same battery SoC set-points, SoC_{d}(i), as in Table II, i.e., it is the case in which only vehicle speed information has been taken into account in the optimization. Compared with the sample route having a constant road grade of zero, the total fuel consumption in the case of “No SoC control” has increased from 0.37 kg to 0.4 kg. This increase may be explained by the presence of a large uphill grade on route segment 2. The fuel consumption in “DP SoC control with grade ignored” case is 7.5% less. As such, a further decrease in fuel consumption of an additional 2.7% results by including the grade information into the optimization algorithm.

TABLE III

| | Total Fuel | |
|---|---|---|
| Supplementary | Consumption | |
| Fuel Savings 2.7% | (kg) | SoC_{d} sequence (%) |
| No SoC control | 0.4 | 50-50-50-50-50-50-50-50 |
| DP SoC control grade ignored | 0.37 | 50-52-50-48-46-46-44-50 |
| DP SoC control grade included | 0.36 | 50-48-48-48-46-46-44-50 |

Similarly to the case of vehicle speed information, road grade information can also constitute a route segmentation criterion. In particular, a significant change in the average grade of the route may prescribe the beginning of a new route segment and an additional battery SoC control point.

As described above, embodiments of the present invention are directed to path-dependent control of a HEV to reduce its fuel consumption along a known or predicted route. The path-dependent control uses information about traveled route and traffic, which may be readily available to present and future vehicles. In particular, the path-dependent control includes an algorithm for battery SoC set-point (i.e., battery SoC control point) optimization along the route. Application of the optimization algorithm has the potential for fuel economy improvements with the level of benefits dependent on a specific route being traveled. The path-dependent control includes certain approaches for segmenting the route into route segments. The route segmentation generally relates to significant changes in average vehicle speed, road grade, the presence of stop signs and traffic lights, and/or traffic congestion. For example, whenever a significant change of the vehicle speed or road grade occurs, a route segment should be made. Accordingly, the resulting segments likely will not have the same length or travel time.

However, in cases where the average speed and grade remain constant for a relatively long duration, embodiments of the present invention may avoid using such long route segments and instead divided these route segments further in order to ensure that the battery SoC control will be frequent enough. For example, these long route segments may be decomposed into smaller route segments of equal distance since the road characteristics are constant and cannot constitute a segmentation criterion any more. Furthermore, the level of segmentation for different road classes can be alternated when part of the route belongs to a road class where, although the average speed and grade remain constant, frequent and steep speed changes are likely to occur (e.g., urban trip with increased traffic), and the segmentation level should be finer than that of a trip where speed changes are small and slow (e.g., the highway).

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. A method comprising:
segmenting a route into segments;
generating a sequence of battery state-of-charge (SoC) set-points for the segments; and
controlling a hybrid electric vehicle in accordance with the battery SoC set-points as the vehicle travels along the route.

2. The method of claim 1 wherein:
segmenting the route into segments is based on vehicle speed along the route such that a node where one segment ends and another segment begins corresponds to the initiation of a change in the vehicle speed at the node.

3. The method of claim 1 wherein:
segmenting the route into segments is based on road grade along the route such that a node where one segment ends and another segment begins corresponds to the initiation of a change in the road grade at the node.

4. The method of claim 1 wherein:
segmenting the route into segments is based on stop signs and traffic lights along the route such that a node where one segment ends and another segment begins corresponds either to the presence of a stop sign or a traffic light at the node.

5. The method of claim 1 wherein:
segmenting the route into segments is based on traffic congestion along the route such that a node where one segments ends and another segment begins corresponds to traffic congestion at the node.

6. The method of claim 1 wherein:
segmenting the route into segments is based on vehicle speed and road grade along the route such that a node where one segment ends and another segment begins corresponds to at least one of the initiation of a change in the vehicle speed and the initiation of a change in the road grade at the node.

7. The method of claim 1 wherein:
the sequence of battery SoC set-points for the segments is generated to minimize fuel consumption of the vehicle such that fuel efficiency of the vehicle is greater when the vehicle is controlled in accordance with the battery SoC set-points as the vehicle travels along the route than when the vehicle is controlled in accordance with a constant battery SoC set-point as the vehicle travels along the route.

8. The method of claim 1 wherein:
the sequence of battery SoC set-points for the segments is generated such that the battery SoC set-point for each segment is based on at least one of the length of the segment, the vehicle speed along the segment, the road grade of the segment, and the battery SoC at the beginning of the segment.

9. The method of claim 1 wherein:
the sequence of battery SoC set-points for the segments is generated such that the battery SoC at the end of the route will be equal to the battery SoC at the origin of the route.

10. The method of claim 1 wherein:
controlling the vehicle in accordance with the battery SoC set-points as the vehicle travels along the route includes updating the battery SoC set-point at each node between route segments and achieving the battery SoC set-point for a segment as the vehicle travels along the segment.

11. A system comprising:
a controller configured to segment a route into segments, generate a sequence of battery state-of-charge (SoC) set-points for the segments, and control a hybrid electric vehicle in accordance with the battery SoC set-points as the vehicle travels along the route.

12. The system of claim 11 wherein:
the controller is further configured to segment the route into segments based on vehicle speed along the route such that a node where one segment ends and another segment begins corresponds to the initiation of a change in the vehicle speed at the node.

13. The system of claim 11 wherein:
the controller is further configured to segment the route into segments based on road grade along the route such that a node where one segment ends and another segment begins corresponds to the initiation of a change in the road grade at the node.

14. The system of claim 11 wherein:
the controller is further configured to segment the route into segments based on stop signs and traffic lights along the route such that a node where one segment ends and another segment begins corresponds either to the presence of a stop sign or a traffic light at the node.

15. The system of claim 11 wherein:
the controller is further configured to segment the route into segments based on traffic congestion along the route such that a node wherein one segment ends and another segment begins corresponds to traffic congestion at the node.

16. The system of claim 11 wherein:
the controller is further configured to segment the route into segments based on vehicle speed and road grade along the route such that a node where one segment ends and another segment begins corresponds to at least one of the initiation of a change in the vehicle speed and the initiation of a change in the road grade at the node.

17. The system of claim 11 wherein:
the controller is configured to generate the sequence of battery SoC set-points for the segments to minimize fuel consumption of the vehicle such that fuel efficiency of the vehicle is greater when the vehicle is controlled in accordance with the battery SoC set-points as the vehicle travels along the route than when the vehicle is controlled in accordance with a constant battery SoC set-point as the vehicle travels along the route.

18. The system of claim 11 wherein:
the controller is configured to generate the sequence of battery SoC set-points for the segments such that the battery SoC set-point for each segment is based on at least one of the length of the segment, the vehicle speed along the segment, the road grade of the segment, and the battery SoC at the beginning of the segment.

19. The system of claim 11 wherein:
the controller is configured to generate the sequence of battery SoC set-points for the segments such that the battery SoC at the end of the route will be equal to the battery SoC at the origin of the route.

20. The system of claim 11 wherein:
the controller is configured to control the vehicle in accordance with the battery SoC set-points as the vehicle travels along the route includes updating the battery SoC set-point at each node between route segments and achieving the battery SoC set-point for a segment as the vehicle travels along the segment.
